(19) United States
(12) Patent Application Publication
(10) Pub. No.: US 2008/0303295 A1
(43) Pub. Date: Dec. 11, 2008

(54) Device for Collecting Faeces and Contaminated Products

(75) Inventor: Ricardo Moreno Fernandez De Betono, Madrid (ES)

Correspondence Address: INTELLECTUAL PROPERTY LAW GROUP LLP, 12 SOUTH FIRST STREET, SUITE 1205, SAN JOSE, CA, 95113, US

(73) Assignee: BIOMED, S.A.

(21) Appl. No.: 10/595,918

(22) PCT Filed: Mar. 23, 2005
(86) PCT No.: PCT/ES2005/000160

§ 371 Date: May 19, 2006

(30) Foreign Application Priority Data
Apr. 19, 2004 (ES) P200400948

(51) Int. Cl. A01K 29/00

(52) U.S. Cl. 294/1.3

(57) ABSTRACT

The invention relates to a device for collecting faeces and contaminated products. The inventive device comprises a re-usable rod (1) and a disposable capsule (2). The rod (1) comprises three concentric tubes, namely: an outer tube (7), an intermediate tube (8) and an inner tube (9), a handle (3) being fixed to the upper end of the outer tube (7). Moreover, an opening lever (4) is articulated to the handle and is connected to the intermediate tube (8) by means of a sliding bushing (5). The lower end of the rod (1) is equipped with two rakes (16) which are articulated to the intermediate tube (8) and which pass through two diametrical slots (15) belonging to an end piece (14) which is solidly connected to the outer tube (7). The aforementioned disposable capsule (2) is formed by two valves (19, 19′) having housings (20) on the side faces thereof, said housings being intended for the elastic reception of corresponding flaps (18) which are disposed on the arms (17) of the rakes (16). Preferably, the edge of the larger valve (19) is equipped with various inner configurations (22) which are designed to house a peripheral flange (24) of the smaller valve (19′)

The present invention refers to a device for the collection of faeces and other contaminating products that presents the characteristics of being aseptic, simple, easy, comfortable and economical. The main utility for which it has been planned is that of facilitating the gathering of deposited dog faeces to persons responsible for the dogs. Other applications are the collection of highly contaminating products that are produced in hospitals and clinics, in such a manner, that risks to health workers in charge of their handling, is avoided.

Numerous procedures have been proposed for dog faeces collection in our streets. Of all of them, the simplest and cheapest, and possibly the one mostly used is the use of plastic bags. This procedure presents a series of clear disadvantages, such as the natural repulsion caused by the sense of touching through the plastic bags experienced during the collect of faeces, the need of having to get near the faeces, and the need of bending down for their collection. This last corporal gesture may be impossible to some people, due to their physical condition.

Likewise known, are devices that include a pole which is provided with various concentric tubes activated by an opening lever and an expulsion pushbutton arranged on the handle, such as the one described in DE 8336136 U. A device such as the one proposed, solves the problem presented by the need of bending down, though not the direct handling of the disposable capsule which additionally, is not watertight.

This problem of lack of watertightness of the disposable capsule is also present in other devices, such as those described in U.S. Pat. No. 3,823,970 and FR 2544354, and in some occasions even providing attachment orifices on the actual capsule, as for example the one in U.S. Pat. No. 5,702,137.

On the other hand, watertight capsules, such as those described in U.S. Pat. No. 4,014,584 and ES 200100491 are known. Both documents describe capsules that are constituted by two halves, joined by means of a strip of the same material. An economic manufacturing of the assembly constituted by the two halves and the strip or hinge, joining them by means of heat forming techniques is very problematical. This is due to the distribution of thicknesses produced during the heat forming. The deeper the mould the more the thickness decreases. If positive moulds are used, a minimum thickness in the hinge strip is obtained, which proves to be appropriate for its flexibility, though a minimum thickness is also obtained at the edge of the valves, which becomes flaccid and does not make the tight closure possible. If negative moulds are used, a maximum thickness is obtained at the edges, which makes possible the tight closure, though this is also obtained at the hinges, thus decreasing the flexibility that is necessary to achieve its bending and the closure of the capsule. Additionally, these hinged capsules are attached to the pole by means of friction mechanisms that produce numerous operational failures due to the difficulty in obtaining the required close tolerances. Finally, this type of capsules occupies a considerable volume because the valves remain joined by the hinge.

In consequence, an object of the present invention is to obtain a device in which the non disposable elements are not soiled by the product to be collected and with which the user does not need to bend down, though offering in turn, by means of the disposable capsule, a safe attachment of the non disposable elements, making them easily releasable without requiring any direct handling.

Another object of the present invention is to make the disposable capsule watertight and easily manufactured, offering a safe and automatic locking system of the two valves, and permitting their insertion into each other in order to minimize the volume occupied during transportation, up to the moment of use.

The device which is the object of the present invention comprises two main parts; a disposable capsule, of very low cost, of the double valve type, in which the collected product is enclosed, and a pole constituted by three concentric tubes that include on their top part, a lever for opening and closing the capsule and a pushbutton which causes its expulsion. On the bottom part, the pole includes the necessary attachment means of the two valves that form the capsule and a plate that pushes the capsule during the expulsion manoeuvre.

The attachment of the capsule is carried out in a safe manner, since both valves present diverse housings on their side planes intended to receive corresponding flaps that internally extend the side arms of two combs that pass through diverse diametrical grooves that are presented by an end part arranged on the bottom part of the pole and that is articulated in the intermediate tube. The latter is moveable by means of the opening lever.

The advantage of this system is that the disposable capsule is handled at a distance (the length of the pole), without requiring bending down. The placement of a new capsule on the pole is carried out by simple pressure. The opening, closing and expulsion manoeuvres are carried out in a reliable and accurate manner with only one hand.

In order to achieve that the capsule remains closed, both valves are preferably asymmetric, with the existence of a smaller valve provided with a perimetrical flange on its edge, and of a larger valve provided with a plurality of internal dimplings intended to retain the perimetrical flange of the smaller valve.

As complement to the above description and with the purpose of aiding to a better understanding of the characteristics of the invention, a detailed description of a preferred embodiment is herewith offered, based on set of drawings enclosed to this specification and in which, simply with illustrative and non limitative character, the following has been represented:

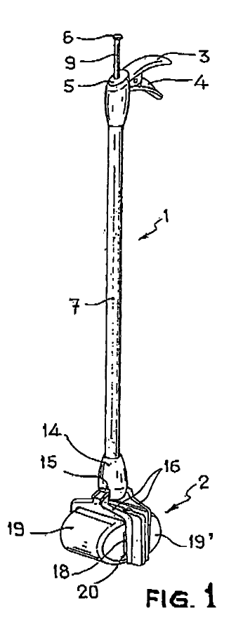

FIG. 1 shows the device which is the object of the invention, in resting position.

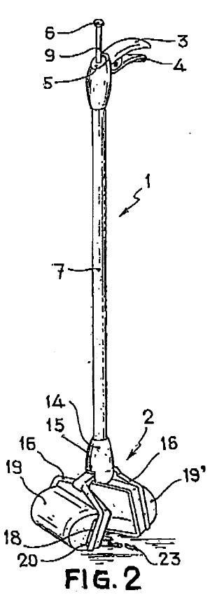

FIG. 2 shows the device which is the object of the invention, whilst the opening lever is activated by hand, in which it can be observed, how the disposable capsule is opened.

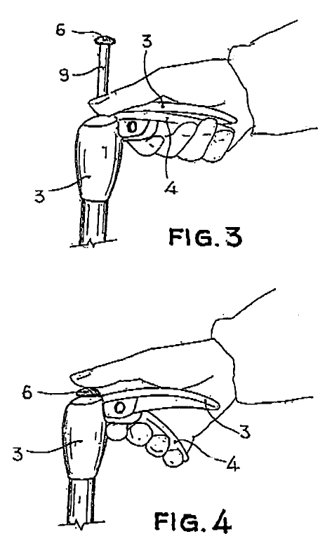

FIG. 3 shows a detailed view of the top end of the pole during the opening of the disposable capsule.

FIG. 4 shows a detailed view of the top end of the pole during the expulsion of the disposable capsule.

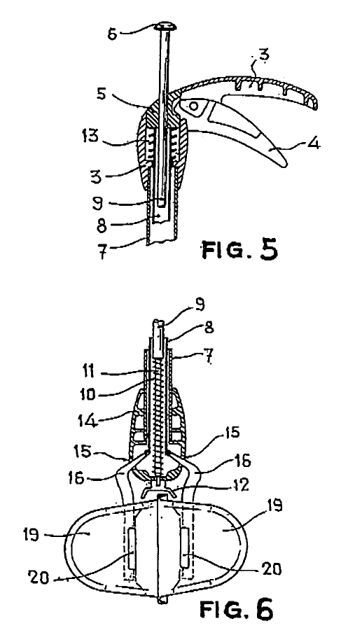

FIG. 5 shows a cross sectional detailed view of the top end of the pole and of the opening and expulsion devices of the disposable capsule.

FIG. 6 shows a cross sectional detailed view of the bottom end of the pole with the opening and expulsion device of the capsule during repose.

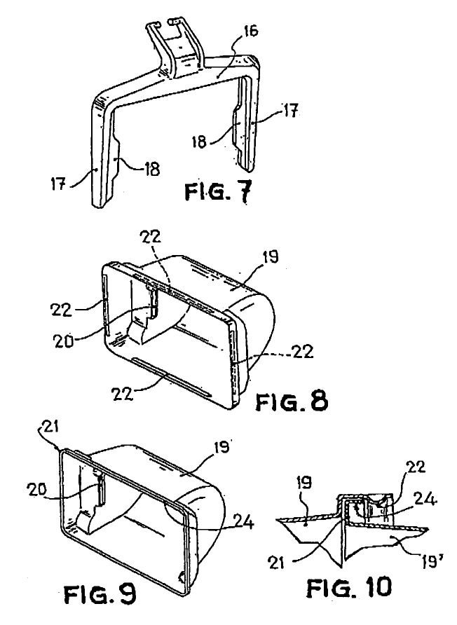

FIG. 7 shows a perspective view of the attachment combs of the disposable capsule.

FIG. 8 shows a perspective view of the larger valve.

FIG. 9 shows a perspective view of the smaller valve.

FIG. 10 shows a detailed view of the coupling of both valves.

In said figures, the numerical references correspond to the following parts and elements:
1.—Pole
2.—Disposable capsule
3.—Handle
4.—Opening lever
5.—Sleeve
6.—Expulsion pushbutton
7.—External tube
8.—Intermediate tube
9.—Internal tube
10.—Antagonistic expulsion spring
11.—Stem
12.—Expulsion plate
13.—Closing spring
14.—End part
15.—Diametrical grooves
16.—Combs
17.—Comb arms
18.—Comb arms flaps
19.—Larger valve
19¹.—Smaller valve
20.—Housings
21.—Edge
22.—Internal dimplings
23.—Product to be collected
24.—Perimetrical flange

As can be observed in FIGS. 1 and 2, the device of the invention consists of a pole (1) provided at its top part with an opening lever (4) and with an expulsion pushbutton (6) that permits the opening, closing and expulsion of a disposable capsule (2).

Pole (1) is made up of an external tube (7) inside of which, an intermediate tube (8) runs through, and in turn, inside of which, an interior tube (9) moves. See FIGS. 5, 6 and 7.

On the top part of the external tube (7) a fixed handle (3) is arranged, on which articulates the opening lever (4), which, by the intervention of a sleeve (5), which slides between the external tube (7) and the internal tube (9), is related to the intermediate tube (8), making it capable of movement against the action of a closing spring (13).

The external tube (7) is widened at its base by an end part (14). This part is provided with two diametrical grooves (15), through which corresponding combs (16) are inserted, each one provided with two arms (17), parallel to each other and perpendicular to the diametrical grooves (15). Combs (16) remain joined in articulated manner to the intermediate tube (8).

From handle (3) the expulsion pushbutton (6) projects, which is joined to the internal tube (9) which passes through the sleeve (5) and extends at its bottom into a stem (11) that ends in an expulsion plate (12). An antagonistic expulsion spring (10) exists surrounding the stem (11), the top stop of which is to be found at the end of the internal tube (9) and the bottom stop of which, is to be found on the inside of the end part (14).

The disposable capsule (2) preferably made from very thin plastic material sheets or with any other biodegradable material, presents two valves (19), (19¹), with semi-cylindrical appearance. Said valves (19), (19¹), though similar, are neither the same nor symmetrical. The size of one of them is slightly smaller than the other and can be totally inserted inside the larger valve, when both valves (19), (19¹) are arranged in the same direction. The larger valve (19) and the smaller valve (19¹) present on their two side planes, corresponding housings (20) intended to elastically receive the flaps (18) of arms (17) of the combs (16), thus attaching the valves to the pole (1).

The smaller valve (19¹) presents an edge (21) that ends with a perimetrical flange (24) intended to be retained inside the internal dimplings (22) that are presented by the larger valve (19) on the four sides of its perimeter. When the smaller valve (19¹) and the larger valve (19) face opposite directions, and are pushed one against the other, the perimetrical flange (24) of the smaller valve (19¹) is placed behind the internal dimplings (22) of the larger valve (19), both valves (19), (19¹) remaining joined to each other, and with the disposable capsule (2) closed.

The device operates as follows. The smaller valve (19¹) is extracted from the larger valve (19) and confront each other, thus providing the closure of the disposable capsule (2) as has been described above in the previous paragraph. Next, the disposable capsule (2) is placed on the combs (16), which aids the flaps (18) of the arms (17) of the combs (16) to be inserted inside the housing (20) of the side planes of the valves (19), (19¹) of the disposable capsule (2). The latter is attached by the combs (16) due to the fit of the flaps (18) inside the housings (20).

In this position, the disposable capsule (2) remains closed by the action of a closing spring (13) placed between the sleeve (5) and a stop arranged inside the handle (3). See FIG. 5.

When it is wished to remove a product to be collected (23) from the ground, the opening lever (4) is manually pressed against the handle (3). The opening lever (4) turns around the handle (3) longitudinally moving the sleeve (5) that compresses the closing spring (13). Simultaneously, the sleeve (5) longitudinally moves the intermediate tube (8), thus tilting the combs (16) as regards the diametrical grooves (15). The tilting movement causes the separation of the combs (16) and the opening of the disposable capsule (2). See FIGS. 2 and 3.

Next, the disposable capsule (2) is placed over the product to be collected (23) in such a manner, that the closing plane coincides with the ground plane. Subsequently, the opening lever (4) is released, allowing the projection of the closing spring (13), that pushes the sleeve (5) upwards, moving the intermediate tube (8) longitudinally once more, in opposite direction, and causing the tilting of the combs (16) in opposite direction with the force provided by the closing spring (13). In this way, the combs (16) are forcibly approximated to the valves (19), (19¹) of the disposable capsule (2), the latter remaining closed with the product to be collected (23) in its interior.

Once in the place where it is wished to deposit the product collected, the expulsion push button (6) is activated by the thumb, causing the descent of the internal tube (9) against the action of the antagonistic expulsion spring (10). In consequence, the stem (11) and the expulsion plate (12) are moved, which push the disposable capsule (2) outside the combs (16) dropping it on the selected deposit. When the expulsion pushbutton (6) is released, the antagonistic expulsion spring (10) returns to its position of rest, moving the internal tube (9) and the expulsion plate (12) to their normal position. See FIG. 4.

In this manner, the pole (1) is ready to be reused again without the user or the pole having been in contact with the product to be collected (23).

It shall be considered evident to experts in the art that variations in the materials employed in the manufacturing of the different elements, their shape and dimensions and all the accessory details, are capable of modifications, provided these do not affect the essentiality of the invention. The disposable capsule (2) may be carried out with any other basic shape other than cylindrical.

1. Faeces and contaminated products collection device, that comprises a disposable capsule (2), a reusable pole(1) the latter being constituted by an external tube (7) inside of which an intermediate tube (8) runs, through which in turn, an interior tube (9) plays, the external tube (7) presenting at its top end, a fixed handle (3) on which an opening lever (4) articulates, which is capable of moving the intermediate tube (8) and through which an expulsion push button (6) projects, joined to the internal tube (9), which extends into a stem (11) ending in an expulsion plate (12), whilst the lower end of the pole (1) is provided with attachment means consisting in an end part (14) provided with two diametrical grooves (15) through which corresponding combs (16) pass through, characterized in that the combs (16) comprise two parallel arms (17) that present internal flaps (18), and in that the disposable capsule (2) is made up of two valves provided on its two Bide planes with corresponding housings (20) intended to elastically receive the flaps (18) of arms (17) of the combs (16).

2. Faeces and contaminated products collection device according to claim 1, characterized in that the two valves are constituted by a smaller valve (19¹) that presents a perimetrical flange (24), and a larger valve (19) that presents on its perimeter, internal dimplings (22) intended to retain the perimetrical flange (24) of the smaller valve (19¹) when both valves (19), (19¹) are confronted in opposite directions.
